(19) United States
(12) Patent Application Publication
(10) Pub. No.: US 2015/0121755 A1
(43) Pub. Date: May 7, 2015

(54) CONFIGURABLE SEGMENTED PLANT POTS

(71) Applicant: W.J. Griffin, Inc., Santa Barbara, CA (US)

(72) Inventor: Brian Caird, Santa Barbara, CA (US)

(73) Assignee: W.J. Griffin, Inc., Santa Barbara, CA (US)

(21) Appl. No.: 14/070,290

(22) Filed: Nov. 1, 2013

(51) Int. Cl. A01G 9/02; A01G 1/00

(52) U.S. Cl. CPC A01G 9/028; A01G 1/001
USPC 47/66.7; 47/86

(57) ABSTRACT

The present invention includes a system and method of aggregating different flowers or plants in a single container. Different plant types (species, colors, sizes, shapes, etc.) are grown in individual smaller pots having particular horizontal cross-sections. A plurality of the individual smaller pots are then closely fit into an outer plant pot to result in substantially no gaps between either the individual plant pots or between the individual plant pots and the outer plant pot. A method of retail marketing of the varieties of different types in the individual smaller pots includes permitting the consumer to mix and match the different types into outer plant pots. A cultivation method involves segregating the different types prior to becoming seedlings to facilitate their unique growing needs, and then providing the consumer access to the varieties at the retail level.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### FIELD OF THE INVENTION

This disclosure relates to plants sold in pots and, more particularly, to a system and method of cultivating individual plant types in separate smaller pots and efficiently combining them in a single larger pot.

### BACKGROUND OF THE DISCLOSURE

At the retail level, plants are sold in containers (pots) from which the consumer removes the plant from the pot and plants in their garden. Plants are sold various sizes of plastic containers:

Cell packs—vegetables, annuals (plants that die each year)

One quart—annuals, perennials (plants that don't die each year and come back)

Two-quarts—perennials

One gallon and up—perennials, shrubs, trees

Bowls/hanging baskets—annuals

The cell packs, one and two quart containers generally are transported from the grower to the retailer in separate, plastic trays. The trays can hold 4, 6 or 8 cell packs, 8, 10, 12, 15 quart containers, or 8 2-quart containers. The customer may purchase an entire tray of potted plants or a single potted plant from the tray.

At the retail level, most plants are displayed by type (annuals, vegetables, herbs, perennials, shrubs and trees), then by variety (marigolds, tomatoes, basil, coneflowers, junipers, and maples). Homeowners typically purchase individual plants or in quantities to augment an existing landscape. If the customer wishes to combine specific plants in an individual pot he/she buys those plants in individual pots, removes the plants and roots and re-pots them together in a larger pot. This is time-consuming especially for multiple combined pots. The process can also cause root damage or plant shock.

There is a need for a more efficient system for combining different types of plants in a single pot.

### SUMMARY OF THE INVENTION

The present application provides an efficient way to combine plant types, such as different plant species in a single pot. The different plant types are provides in a plurality of smaller pots that closely-pack into a larger pot for a pleasing appearance. The technique increases shelf life of the resulting plants because otherwise removing or transplanting the plants out of one smaller pot and into a larger pot in conjunction with other plants and roots can cause root damage or plant shock.

In accordance with one aspect, a combination of planter pots comprises a plurality of individual plant pots each having plants therein, the individual plant pots having horizontal cross-sectional shapes. A single outer plant pot has a horizontal cross-sectional shape into which the plurality of individual plant pots closely fit to result in substantially no gaps between either the individual plant pots or between the individual plant pots and the outer plant pot.

A method of marketing plants is also disclosed that includes providing, in a retail establishment, a plurality of individual plant pots each having plants therein, the individual plant pots having horizontal cross-sectional shapes. Near the plurality of individual plant pots, a plurality of outer plant pots are provided each having a horizontal cross-sectional shape into which the plurality of individual plant pots can closely fit to result in substantially no gaps between either the individual plant pots or between the individual plant pots and the outer plant pot. Consumers are then permitted to mix and match a plurality of individual plant pots to be combined within one of the outer plant pots.

A method of cultivating and marketing different types of plants is also disclosed herein. The method includes the step of cultivating from seeds to seedlings a plurality of different types of plants according to their respective needs, each of the plants being grown in an individual plant pot having a horizontal cross-sectional shape. A plurality of groups of the different types of plant seedlings in the individual plant pots are provided in a retail establishment. Near the plurality of individual plant pots, a plurality of outer plant pots are provided. Each outer plant pot has a horizontal cross-sectional shape into which the plurality of individual plant pots can closely fit to result in substantially no gaps between either the individual plant pots or between the individual plant pots and the outer plant pot. Consumers are then permitted to mix and match a plurality of individual plant pots to be combined within one of the outer plant pots.

Desirably, each of the individual plant pots contains a different plant type. In one embodiment, each of the individual plant pots has the same horizontal cross-sectional shape, or at least two of the individual plant pots may have different horizontal cross-sectional shapes. In one arrangement, the horizontal cross-sectional shape of one of the individual plant pots is different than the horizontal cross-sectional shapes of all the other individual plant pots. The individual plant pots may have pie-shaped horizontal cross-section sections, and the outer plant pot has a circular horizontal cross-section.

### DESCRIPTION OF THE DRAWINGS

FIG. 1A is an exploded view of three separate smaller segmented pots being assembled into a larger cylindrical pot, and FIG. 1B is the resulting assembly;

FIG. 2A is an exploded view of four separate smaller square pots being assembled into a larger square pot, and FIG. 2B is the resulting assembly;

FIG. 3 is a top plan view of three smaller pie-shaped pots fitted within a larger circular pot;

FIG. 4 is a top plan view of three smaller trapezoidal-shaped pots fitted within a larger trapezoidal pot;

FIG. 5 is a top plan view of four smaller triangular-shaped pots fitted within a larger triangular pot;

FIG. 6 is a top plan view of four smaller quarter-oval-shaped pots fitted within a larger oval pot;

FIG. 7 is a top plan view of five smaller triangular-shaped pots and a circular pot fitted within a larger star-shaped pot;

FIG. 8 shows three separate planter boxes each having a plurality of smaller segmented pots therein having the same plant species;

FIGS. 9A-9C are top plan views of three different combinations of the different plant species from the planter boxes of FIG. 8 with smaller segmented pots placed within a larger pot;

FIGS. 10A-10C are perspective views of the combined plant species corresponding to those schematically shown in FIGS. 9A-9C.

Throughout this description, elements appearing in figures are assigned three-digit reference designators, where the most significant digit is the figure number where the element is introduced and the two least significant digits are specific to the element. An element that is not described in conjunction with a figure may be presumed to have the same characteristics and function as a previously-described element having the same reference designator.

### DETAILED DESCRIPTION

The present application provides a solution for consumers who wish to buy separate plant types and combined in a single pot. Whereas previously a laborious chore of removing each types from separate smaller pots and putting them in a larger container was required, the present application enables the consumers to simply buy the separate smaller pots and combined them closely into a larger container without removing the plants from the pots. Or, the consumer may purchase just the smaller pots for separate display or transplant.

The term “pot” refers to any container which is typically used for growing plants, including perennials, annuals, fruits, vegetables, etc. The pot may be sized and configured to contain dirt, or another growing medium such as wood chips, clay beads, and the like. Furthermore, the pot may not contain a growing medium such as for holding epiphytes. The materials for the separate smaller or larger pots may be plastic, ceramic, wood, or other typical pot materials. Alternatively, the pots may be made of biodegradable materials.

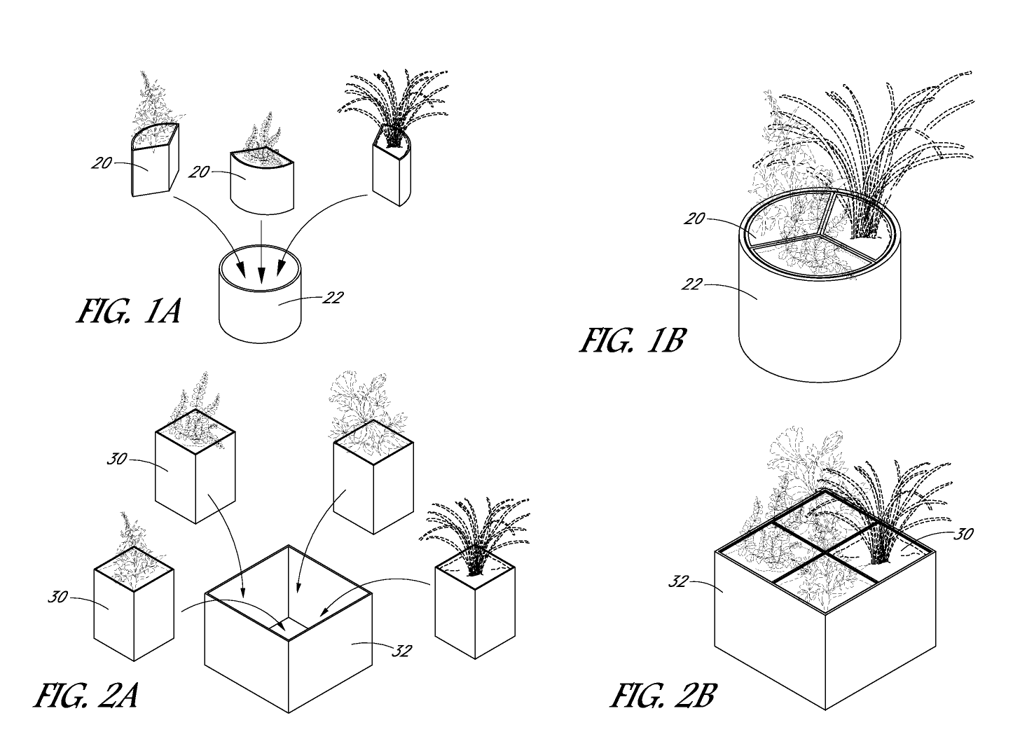

FIG. 1A shows three separate smaller segmented pots 20 being assembled into a larger cylindrical pot 22. Each of the segmented pots 20 has a horizontal cross-section configuration which is pie-shaped so that multiple segments can be combined and fit into the larger pot 22 which is circular in horizontal cross-section. The segmented pots 20 each contain dirt and, preferably, a separate plant species, as indicated by the different visual configuration of plants. FIG. 1B is the resulting close-fit assembly, which provides a pleasing assembly of the three different plant species in a single pot 22. Alternatively, three of the same species of flower with different colors could be combined for a pleasing appearance. The present application thus contemplates the mixing and matching of two or more different plant types (species, colors, sizes, shapes, etc.) into a single pot.

It should be noted that with three close-fit segmented pots 20, each pot has a 120° pie-shaped horizontal cross-section. Of course, two or more than three pots 20 can be combined, with the horizontal cross-section of varying accordingly. For example, the combination of five pots 20 means that each pot has a 72° pie-shaped horizontal cross-section. Furthermore, the sizes of the larger pots 22 may vary, with the sizes of the smaller pots 20 changing proportionately. For example, the larger pots 22 may be provided in 4, 6, or 8 inch or larger diameters, with the three pie-shaped pots 20 having a radius from an inner apex to the outer curved wall of one half of the diameter of the larger pot. The depth of the smaller or larger pots are similar, and of course may vary, with the smaller pots typically being slightly shorter than the larger pots.

FIG. 2A shows four separate smaller square pots 30 being assembled into a larger square pot 32. Again, each one of the smaller square pots 30 contains dirt and a separate plant species, such that when combined as in FIG. 2B the resulting assembly has the four separate plant species. Again, the arrangement provides the ability to mix-and-match four different plant types (species, colors, sizes, shapes, etc.) into a single pot.

While in the past and a number of smaller pots which could fit within the volume of larger pot could be combined, the present application contemplates closely fitting a plurality of smaller pots into a larger pot. The term “closely fitting” or “close-pack” refers to the smaller pots fitting within the larger pot so that there are substantially no gaps or empty volume left between either the smaller pots or between the smaller pots and the outer larger pot. This maximizes the growing volume within the larger pot, and efficiently combines the different plant types. Furthermore, the size of the larger pot is as small as possible, as the horizontal cross-section approximately equals the aggregate of the horizontal cross-sections of the smaller pots. Of course, in order to fit smaller pots within larger pots a small amount of clearance is necessary between the respective pots, and thus there are by necessity nominal gaps between the pots.

The permutations of combining separate smaller pots so as to fit closely into one larger pot are endless. For example, FIG. 3 is a top plan view of the three smaller pie-shaped pots 20 from FIG. 1A fitted within the larger circular pot 22. FIG. 4 shows three smaller trapezoidal-shaped pots 40 fitted within a larger trapezoidal pot 42. FIG. 5 shows four smaller identical equilateral triangular-shaped pots 50 fitted within a larger equilateral triangular pot 52. In FIG. 6, four smaller quarter-oval-shaped pots 60 fit closely within a larger oval pot 62.

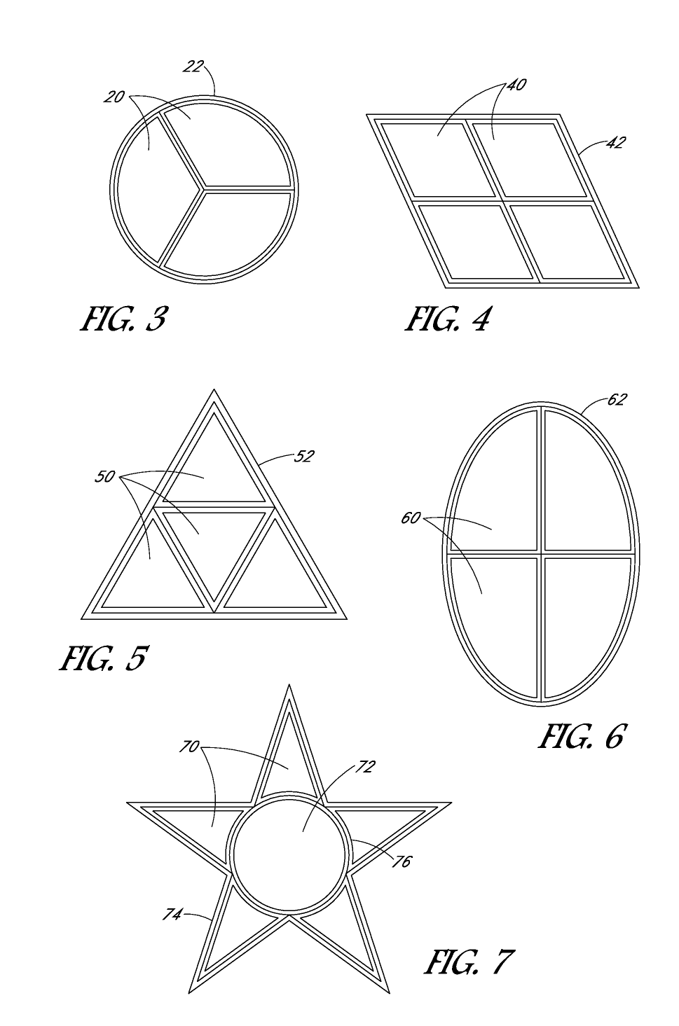

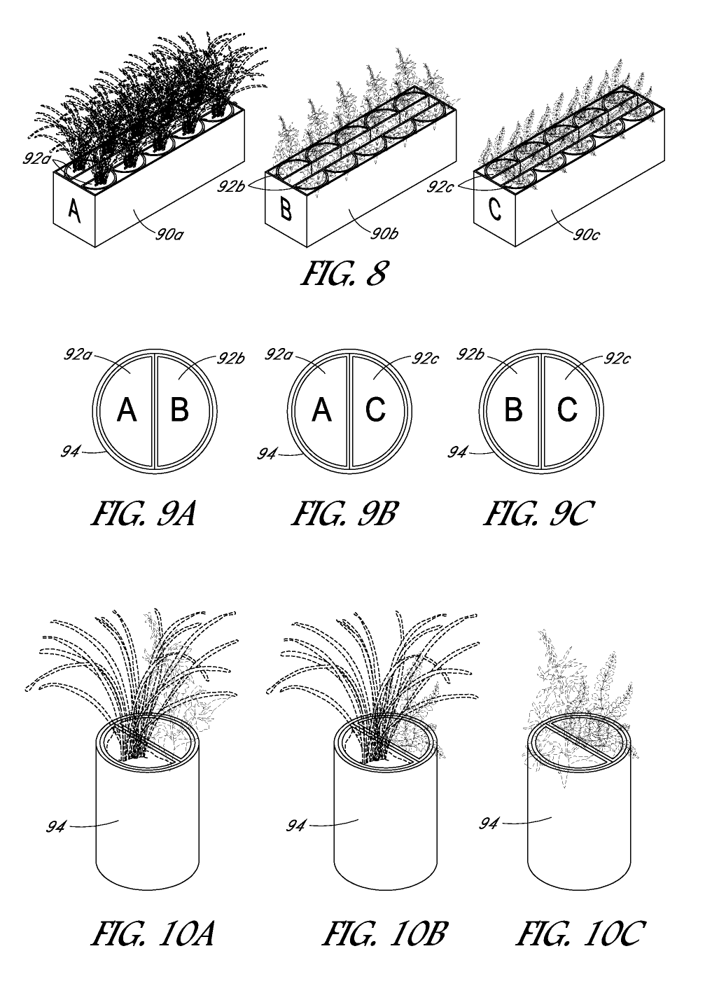

FIG. 7 is a top plan view of five smaller triangular-shaped pots 70 and an inner circular pot 72 fitted within a larger star-shaped pot 74. The triangular-shaped pots 70 have partial circular inner walls 76 that conform to the inner circular pot 72. FIG. 7 is symbolic of any close-packed smaller pots within a larger pot, as described in the present application, where the smaller pots have more than one cross-sectional shape. The reader will therefore understand that the present application contemplates any combination of smaller pots that are close-packed into larger pots. One of the simplest variations is shown in FIGS. 9A-9C, described below, and includes two identically-shaped smaller pots fitted within a larger pot. FIG. 7 illustrates a combination of a plurality of smaller pots with at least two that are different fitted within a larger pot. Indeed, the present application discloses a number of “regular” shapes of pots, such as circular, square, etc. However irregular or random shapes are contemplated as long as the smaller pots are closely-packed into the larger pot.

The present application also discloses a method of plant cultivation in which different types of plants are cultivated separately and then combined when ready to display in the retail space or at the time of purchase by the consumer. For instance, different plant species have different requirements in terms of watering, fertilizer requirements, sun exposure, etc., and growers often segregate different species in their formative stages. Once the plants have developed into seedlings, their particular requirements may not be so distinct, and therefore they can be combined with other varieties. A method of cultivation disclosed herein includes starting different plant species in separate containers until they reach a desired maturity, and then presenting them for combination with other plant species that have been similarly nurtured. More generally, the exemplary method provides the ability to separately cultivate different plant types (species, colors, sizes, shapes, etc.) for later combination. Indeed, one method could involve separately cultivating the same species but nurturing the plants differently so that the separate groups develop differently, such as by differently fertilizing or pruning one or more groups to be later combined for a pleasing arrangement.

In an exemplary method, FIG. 8 shows three separate long rectangular planter boxes 90a, 90b, 90c each having a plurality of smaller segmented pots 92a, 92b, 92c therein having the same plant types. That is, planter box 90a has plant type A therein, planter box 90b has plant type B therein, and planter box 90c has plant type C therein. The different plant types are indicated by differently-shaped leaves and shapes. Each separate planter box 90a, 90b, 90c represents any number of segregated areas in which the different plant types may be separately cultivated. That is, the planter boxes 90 may be representative of separate areas or rooms within a cultivation facility, or simply separate containers within which the seeds are cultivated into seedlings.

FIGS. 9A-9C show top plan views of three different combinations of the different plant types A, B, C from the previously segregated planter boxes of FIG. 8. That is, the smaller segmented pots 92a, 92b, 92c are mixed and matched within larger pots 94. In FIG. 9A, type A is combined with type B, in FIG. 9B, type A is combined with type C, and in FIG. 9C, type B is combined with type C. The smaller segmented pots 92 are semi-circular in horizontal cross-section, and closely fit within circular cross-sectional larger pots 94. Again, this is a relatively simple shape combination, and is representative of numerous other more complex arrangements.

FIGS. 10A-10C show the combined plant types A, B, C corresponding to those schematically shown in FIGS. 9A-9C. It is thus apparent that numerous combinations of plants can be combined in this manner for a variety of results. For example, flowers having complementary colors, different varieties of herbs, striking arrangements of succulents; all can be combined limited only by the imagination of the customer. In terms of the actual retail process, the combinations of different types may be made either by the seller or the buyer. For example, the plant store or nursery can cultivate the different types separately and then combine them in desirable ways for direct sale to the customer. Alternatively, the retailer can provide multiple varieties of the plant types in the smaller pots for combination by the customer at the time of purchase. Suggestions as to attractive or desirable combinations can be made by the retailer, verbally or on instruction sheets, or actual examples of such combinations can be displayed to assist the customer.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A combination of planter pots, comprising:
a) a plurality of individual plant pots each having plants therein, the individual plant pots having horizontal cross-sectional shapes; and
b) a single outer plant pot having a horizontal cross-sectional shape into which the plurality of individual plant pots closely fit to result in substantially no gaps between either the individual plant pots or between the individual plant pots and the outer plant pot.

2. The combination of claim 1, wherein each of the individual plant pots contains a different plant type.

3. The combination of claim 1, wherein each of the individual plant pots has the same horizontal cross-sectional shape.

4. The combination of claim 1, wherein at least two of the individual plant pots have different horizontal cross-sectional shapes.

5. The combination of claim 4, wherein the horizontal cross-sectional shape of one of the individual plant pots is different than the horizontal cross-sectional shapes of all the other individual plant pots.

6. The combination of claim 1, wherein the individual plant pots have pie-shaped horizontal cross-section sections, and the outer plant pot has a circular horizontal cross-section.

7. The combination of claim 6, wherein there are three individual plant pots each comprising a 120° pie-shaped horizontal cross-section.

8. A method of marketing plants, comprising:
a) providing in a retail establishment a plurality of individual plant pots each having plants therein, the individual plant pots having horizontal cross-sectional shapes;
b) providing in the retail establishment and near the plurality of individual plant pots a plurality of outer plant pots each having a horizontal cross-sectional shape into which the plurality of individual plant pots can closely fit to result in substantially no gaps between either the individual plant pots or between the individual plant pots and the outer plant pot; and
c) permitting consumers to mix and match a plurality of individual plant pots to be combined within one of the outer plant pots.

9. The method of claim 8, wherein a plurality of different plant types are provided in groups of individual plant pots.

10. The method of claim 8, wherein in at least one combination of individual plant pots that closely fit within an outer plant pot, each of the individual plant pots has the same horizontal cross-sectional shape.

11. The method of claim 8, wherein in at least one combination of individual plant pots that closely fit within an outer plant pot, at least two of the individual plant pots have different horizontal cross-sectional shapes.

12. The combination of claim 11, wherein in at least one combination of individual plant pots that closely fit within an outer plant pot, the horizontal cross-sectional shape of one of the individual plant pots is different than the horizontal cross-sectional shapes of all the other individual plant pots.

13. The method of claim 8, wherein in at least one combination of individual plant pots that closely fit within an outer plant pot the individual plant pots have pie-shaped horizontal cross-section sections, and the outer plant pot has a circular horizontal cross-section.

14. The combination of claim 13, wherein there are three individual plant pots in the combination each comprising a 120° pie-shaped horizontal cross-section.

15. A method of cultivating and marketing different types of plants, comprising:
a) cultivating from seeds to seedlings a plurality of different types of plants according to their respective needs, each of the plants being grown in an individual plant pot having a horizontal cross-sectional shape;
b) providing in a retail establishment a plurality of groups of the different types of plant seedlings in the individual plant pots;
c) providing in the retail establishment and near the plurality of individual plant pots a plurality of outer plant pots each having a horizontal cross-sectional shape into which the plurality of individual plant pots can closely fit to result in substantially no gaps between either the individual plant pots or between the individual plant pots and the outer plant pot; and
d) permitting consumers to mix and match a plurality of individual plant pots to be combined within one of the outer plant pots.

16. The method of claim 15, wherein in at least one combination of individual plant pots that closely fit within an outer plant pot, each of the individual plant pots has the same horizontal cross-sectional shape.

17. The method of claim 15, wherein in at least one combination of individual plant pots that closely fit within an outer plant pot, at least two of the individual plant pots have different horizontal cross-sectional shapes.

18. The combination of claim 17, wherein in the combination in which at least two of the individual plant pots have different horizontal cross-sectional shapes, the horizontal cross-sectional shape of one of the individual plant pots is different than the horizontal cross-sectional shapes of all the other individual plant pots.

19. The method of claim 15, wherein in at least one combination of individual plant pots that closely fit within an outer plant pot the individual plant pots have pie-shaped horizontal cross-section sections, and the outer plant pot has a circular horizontal cross-section.

20. The combination of claim 19, wherein there are three individual plant pots in the combination each comprising a 120° pie-shaped horizontal cross-section.
